(19) United States
(12) Patent Application Publication
(10) Pub. No.: US 2011/0267734 A1
(43) Pub. Date: Nov. 3, 2011

(54) SWITCHGEAR OPERATING APPARATUS AND THREE-PHASE SWITCHGEAR

(75) Inventors: Takakazu Inoue, Tokyo (JP); Yasushi Takeuchi, Tokyo (JP)

(73) Assignee: Mitsubishi Electric Corporation, Chiyoda-ku (JP)

(21) Appl. No.: 13/144,520

(22) PCT Filed: Mar. 31, 2010
(86) PCT No.: PCT/JP2010/002359

§ 371 Date: Jul. 14, 2011

(30) Foreign Application Priority Data
Apr. 2, 2009 (JP) 2009-089663

(51) Int. Cl. H01H 47/22

(52) U.S. Cl. 361/160

(57) ABSTRACT

A switchgear operating apparatus provided with an electronic switching device (7) connected to a negative electrode side of a DC power supply and a plurality of operating coils (4) which are simultaneously energized and controlled by the electronic switching device (7) for performing on/off operations of a three-phase switchgear includes diodes (6a, 6b, 6c) connected between the individual operating coils (4) and the electronic switching device (7), and a voltage detector (9) for detecting potential differences applied to the individual diodes (6a, 6b, 6c) and the electronic switching device (7).

### TECHNICAL FIELD

The present invention relates to a switchgear operating apparatus having coils for performing on/off operations of a switchgear and a three-phase switchgear and, in particular, the invention is concerned with detection of a circuit disconnection.

### BACKGROUND ART

A conventional switchgear operating apparatus for performing on/off operations of a switchgear by means of coils is configured with the coils for driving main circuit on/off devices (e.g., vacuum switch valves) to open and close, a power supply for feeding electric power to the coils and a switch for controlling delivery of power to the coils. The coils are energized when the switch is closed, whereby the switchgear is driven to open or close (refer to Patent Document 1, for example).

### PRIOR ART DOCUMENT

### Patent Document

Patent Document 1: Japanese Patent Application Publication No. 2003-16887

### SUMMARY OF THE INVENTION

### Problems to be Solved by the Invention

A conventional switchgear operating apparatus in which a switchgear is directly driven by coils in operation is not provided with any means for detecting the occurrence of a circuit disconnection in case the same occurs in a driving circuit including a power supply, a switch and coils. For this reason, there has been a problem that one would notice the occurrence of the circuit disconnection in the driving circuit only after the occurrence of an operational error in an opening or closing operation performed after the occurrence of the circuit disconnection.

The present invention has been made to solve the aforementioned problem. Accordingly, it is an object of the invention to provide a switchgear operating apparatus and a three-phase switchgear that can detect an abnormal situation which may occur when preventing an incomplete opening or closing operation, for example, in the event of a circuit disconnection in a driving circuit or in the event of a circuit disconnection in one phase among three phases.

### Means for Solving the Problems

The present invention provides a switchgear operating apparatus provided with switching means connected to a negative electrode side of a DC power supply and a plurality of operating coils which are simultaneously energized and controlled by the switching means for performing on/off operations of a three-phase switchgear, the switchgear operating apparatus including rectifying devices connected between the individual operating coils and the switching means, and detection means for detecting potential differences applied to the individual rectifying devices and the switching means.

The present invention also provides a three-phase switchgear including a switchgear operating apparatus provided with switching means connected to a negative electrode side of a DC power supply and a plurality of operating coils which are simultaneously energized and controlled by the switching means for performing on/off operations of the three-phase switchgear, the switchgear operating apparatus including rectifying devices connected between the individual operating coils and the switching means, and detection means for detecting potential differences applied to the individual rectifying devices and the switching means.

### Advantageous Effects of the Invention

A switchgear operating apparatus according to the present invention is provided with switching means connected to a negative electrode side of a DC power supply and a plurality of operating coils which are simultaneously energized and controlled by the switching means for performing on/off operations of a three-phase switchgear, the switchgear operating apparatus including rectifying devices connected between the individual operating coils and the switching means, and detection means for detecting potential differences applied to the individual rectifying devices and the switching means. It is therefore possible to detect a wide range of anomalies caused by a circuit disconnection, for example.

A three-phase switchgear according to the present invention includes a switchgear operating apparatus provided with switching means connected to a negative electrode side of a DC power supply and a plurality of operating coils which are simultaneously energized and controlled by the switching means for performing on/off operations of the three-phase switchgear, the switchgear operating apparatus including rectifying devices connected between the individual operating coils and the switching means, and detection means for detecting potential differences applied to the individual rectifying devices and the switching means. It is therefore possible to detect a wide range of anomalies caused by a circuit disconnection, for example.

### BRIEF DESCRIPTION OF THE DRAWING

FIG. 1 is a diagram depicting the configuration of a switchgear operating apparatus according to a first embodiment of the present invention.

### MODE OF CARRYING OUT THE INVENTION

### First Embodiment

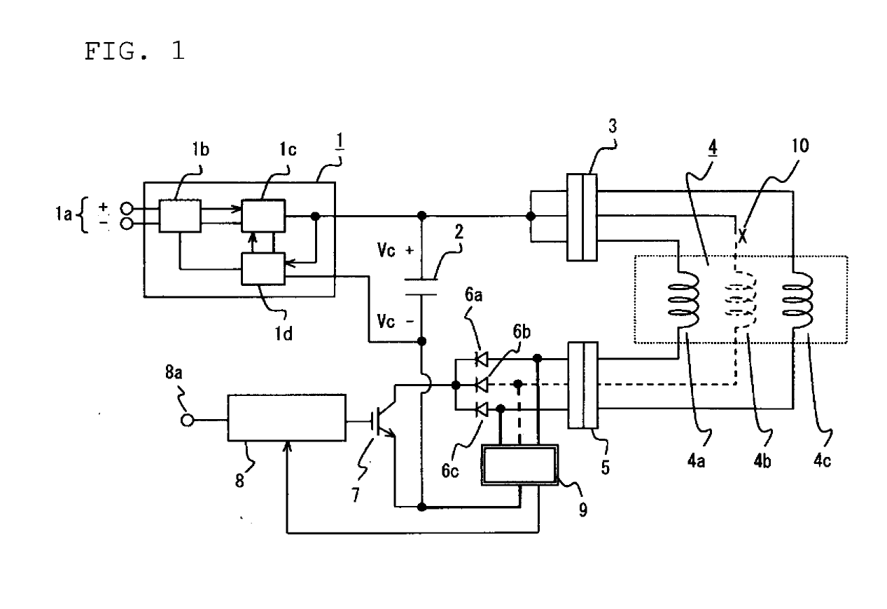

A mode of carrying out the present invention is described hereinbelow. FIG. 1 is a diagram depicting the configuration of a switchgear operating apparatus according to a first embodiment of the invention. The switchgear operating apparatus of the first embodiment which is provided with a driving circuit configured with a power supply, operating coils and a driving switch is for performing on/off operations of a three-phase switchgear. Referring to the FIGURE, the switchgear operating apparatus includes a charging circuit section 1 connected to power input terminals 1a, a capacitor 2 for storing electric power that serves as a DC power supply connected to the charging circuit section 1, an electronic switching device 7 that serves as switching means connected to a negative electrode side of the capacitor 2, operating coils 4a, 4b, 4c for each of three phases that are simultaneously energized and controlled by the electronic switching device 7, diodes 6a, 6b, 6c that are connected between the individual operating coils 4a, 4b, 4c and the electronic switching device 7, respectively, to serve as rectifying devices for separating the three phases from one another, a first connector 3 for connecting a positive electrode side of the capacitor 2 to the individual operating coils 4a, 4b, 4c and a second connector 5 for connecting the operating coils 4a, 4b, 4c to the respective diodes 6a, 6b, 6c. The charging circuit section 1 includes a noise filter 1b that blocks external noise and overvoltage to prevent misoperation and breakage, a DC-DC converter 1c that converts an input voltage into a voltage at which the capacitor 2 is charged, and a voltage monitoring circuit 1d that monitors the amount of electric charge charged into the capacitor 2 in terms of a voltage and feeds back this voltage for regulating an output of the DC-DC converter 1c.

The switchgear operating apparatus of FIG. 1 also includes a switching controller 8 for controlling the electronic switching device 7, an input terminal 8a through which a command signal is input into the switching controller 8, and a voltage detector 9 that serves as detection means which detects potential differences applied to the individual diodes 6a, 6b, 6c and the electronic switching device 7 and, upon detecting that a detected voltage differs from a specified value, outputs an anomaly detection signal on the assumption that an abnormal situation has occurred. It is to be noted that the “specified value” mentioned above refers to a voltage value or a range of voltage values that should normally be detected. Also, the switchgear operating apparatus may be configured such that electric power for driving the voltage detector 9 is supplied from the capacitor 2.

Described below is how an anomaly is detected by the switchgear operating apparatus of the first embodiment configured as mentioned above. First, the voltage detector 9 monitors voltages of circuits of the individual phases by detecting potential differences applied to the individual diodes 6a, 6b, 6c and the electronic switching device 7. Then, when a circuit disconnection occurs at a point of open circuit 10, a voltage is lost at the operating coil 4b and the diode 6b which are located downstream of the relevant open circuit point 10. For the sake of explanation, FIG. 1 depicts the open circuit point 10 with a downstream portion therefrom shown by broken lines indicating that the voltage is lost. Upon detecting this voltage loss, the voltage detector 9 senses that the detected voltage differs from the specified value and transmits the anomaly detection signal in the form of an alarm, for example, on the assumption that an abnormal situation has occurred. In addition, the voltage detector 9 transmits a signal for locking operation for preventing incomplete opening or closing operation as another anomaly detection signal to the exterior (not shown) and/or the switching controller 8. A reason why the voltage loss can be detected by the voltage detector 9 in this fashion is that the provision of the diode 6b serves to prevent a situation where potentials of the circuits of the individual phases including the operating coils 4a, 4c in which no open circuit has occurred become equal to a potential of the circuit of the phase including the operating coil 4b in which the open circuit has occurred. This arrangement makes it possible to detect the open circuit at the open circuit point 10.

Anomalies that can be detected include a situation in which “an open circuit has occurred in an operating coil or in a circuit including the same”, a situation in which “a connector in a circuit including a coil has been disconnected (loose connection)” and a situation in which “a power supply voltage has been lost”. It is to be noted that disconnection of a connector has a high probability of occurrence and this anomaly is detectable.

According to the switchgear operating apparatus of the first embodiment described above, the voltage detector detects a voltage loss caused by an open circuit, for instance, by detecting potential differences applied to the individual operating coils and the electronic switching device and monitoring the voltages of the circuits of the individual phases. By detecting this kind of voltage loss, the voltage detector can transmit an alarm and a signal for locking operation for preventing incomplete opening or closing operation to the exterior (not shown) and/or the switching controller. Therefore, it is possible to detect a wide range of anomalies caused by a circuit disconnection, for example.

Also, it is possible to supply power for driving the voltage detector from the capacitor. In this case, it is not necessary to provide an extra driving power supply.

The present invention is applicable similarly to switchgear operating apparatuses not only for circuit breakers like VCB or GCB but also for switchgears which are directly driven by operating coils, thus generating like advantageous effects.

1. A switchgear operating apparatus provided with switching means connected to a negative electrode side of a DC power supply and a plurality of operating coils which are simultaneously energized and controlled by said switching means for performing on/off operations of a three-phase switchgear, said switchgear operating apparatus comprising:
rectifying devices connected between said individual operating coils and said switching means; and
detection means for detecting potential differences applied to said individual rectifying devices and said switching means.

2. The switchgear operating apparatus as recited in claim 1, wherein an anomaly detection signal is output when any of the potential differences detected by said detection means differs from a specified value.

3. A three-phase switchgear of which on/off operations are performed by a switchgear operating apparatus provided with a switching section connected to a negative electrode side of a DC power supply and a plurality of operating coils which are simultaneously energized and controlled by said switching section, said switchgear operating apparatus comprising:
rectifying devices connected between said individual operating coils and said switching means; and
a detecting section for detecting potential differences applied to said individual rectifying devices and said switching section.

4. The three-phase switchgear as recited in claim 3, wherein said switchgear operating apparatus outputs an anomaly detection signal when any of the potential differences detected by said detecting section differs from a specified value.
